(19) United States
(12) Patent Application Publication
(10) Pub. No.: US 2026/0167079 A1
(43) Pub. Date: Jun. 18, 2026

(54) VEHICLE SEATBACK

(71) Applicants: Hyundai Motor Company, Seoul (KR); Kia Corporation, Seoul (KR); Hyundai Transys Inc., Seosan-si (KR)

(72) Inventors: Eun Sue KIM, Hwaseong-Si (KR); Sang Hark LEE, Hwaseong-Si (KR); Ji Yun HA, Hwaseong-Si (KR); Soo Bok KIM, Hwaseong-Si (KR); Jun Hyung KWON, Hwaseong-Si (KR); Duk Kyu BYUN, Hwaseong-Si (KR); Sin Jeong KANG, Hwaseong-Si (KR); Seong Bin JEONG, Hwaseong-Si (KR)

(21) Appl. No.: 19/202,783

(22) Filed: May 8, 2025

(30) Foreign Application Priority Data
Dec. 12, 2024 (KR) 10-2024-0184956

(51) Int. Cl. B60N 3/00

(52) U.S. Cl. CPC B60N 3/004

(57) ABSTRACT

A vehicle seatback includes a mounting guide protruding rearward from the seatback and/or stowed inside the seatback (e.g., by rotation) and a guide locking device for locking and/or unlocking the mounting guide (e.g., into or out from a stowed state inside the seatback). Vertical height, relative to the seatback, of a convenience device installed in the seatback may be adjusted and/or fixed in the mounting guide.

### CROSS-REFERENCE TO RELATED APPLICATION

The present application claims priority to Korean Patent Application No. 10-2024-0184956, filed Dec. 12, 2024, the entire contents of which is incorporated herein for all purposes by this reference.

### TECHNICAL FIELD

The present disclosure relates to the structure of a vehicle seatback.

### BACKGROUND

Vehicles are equipped with seats for occupants. Each seat typically includes a seat cushion for an occupant to sit on and a seatback supporting the occupant's back.

In recent years, vehicle seats have increasingly come with various convenience features. These convenience features are typically integrated and fixed inside the seat cushion or seatback. Once adopted in the seat, these convenience features are difficult to replace or modify.

The matters described above as background technology are intended to facilitate a better understanding of the background of the present disclosure and are not to be taken as an admission that the present disclosure pertains to the conventional technology already known to those skilled in the art.

### SUMMARY

The following summary presents a simplified summary of certain features. The summary is not an extensive overview and is not intended to identify key or critical elements.

Systems, apparatuses, and methods are described for a vehicle seatback. A vehicle seatback may comprise: a mounting guide configured to switch, by rotation, between: a protruding state in which the mounting guide protrudes rearward from the vehicle seatback, and a stowed state in which the mounting guide is stowed inside the vehicle seatback; and a guide locking device configured to: lock the mounting guide into the stowed state, or unlock the mounting guide from the stowed state, wherein the mounting guide is configured to accommodate a convenience device installed on the mounting guide such that a position, of the convenience device along the mounting guide in a length direction of the mounting guide, is able to be adjusted and fixed.

A convenience device may be configured to be installed on a mounting guide in the vehicle seatback. The convenience device may comprise: a guide hole configured to accept insertion of the mounting guide; the locking lever configured to be inserted into a guide locking groove of the plurality of guide locking grooves of the mounting guide inserted in the guide hole; and a lever spring configured to elastically support the locking lever toward the guide locking groove.

A seatback may comprise: a mounting guide comprising a plurality of mounting guide bars rotatably attached to the seatback and configured to switch, by rotation, between: a protruding state in which the plurality of mounting guide bars protrude rearward from the seatback, and a stowed state in which the plurality of mounting guide bars are stowed inside the seatback; wherein each mounting guide bar, of the plurality of mounting guide bars, forms a plurality of guide locking grooves spaced apart in a length direction of the mounting guide; and a convenience device comprising: a plurality of guide holes configured to accept insertion of the plurality of mounting guide bars, wherein each of the plurality of guide holes comprises: a locking lever configured to be inserted into a guide locking groove of the plurality of guide locking grooves of an inserted mounting guide bar of the plurality of mounting guide bars; and a lever spring configured to elastically support the locking lever toward the guide locking groove.

These and other features and advantages are described in greater detail below.

### BRIEF DESCRIPTION OF THE DRAWINGS

FIG. 1 is a view illustrating a vehicle seatback according to the present disclosure.

FIG. 2 is a front view of the vehicle seatback in FIG. 1.

FIG. 3 is a view describing the concept of installing a convenience device to a vehicle seatback according to the present disclosure.

FIG. 4 is a view describing a state in which a hinge portion of a mounting frame of the present disclosure is rotatably supported elastically.

FIG. 5 is a detailed view illustrating the main parts in FIG. 4 from another perspective.

FIG. 6 is a view illustrating components coupled to a hinge portion of a mounting frame.

FIGS. 7 and 8 are views describing a structure in which the rotation of a hinge portion of a mounting frame is restrained.

FIG. 9 is a conceptual view describing a state in which a convenience device is supported by a mounting guide.

FIG. 10 is a cross-sectional view taken along F10-F10 in FIG. 9.

FIG. 11 is a longitudinal view taken along F11-F11 in FIG. 10.

FIG. 12 is a view describing a structure in which electric power is provided to a convenience device.

FIG. 13 is a view illustrating a state in which a mounting frame is locked by a guide locking device.

FIG. 14 is a detailed view of key parts around the locking slider on one side in FIG. 13 viewed from the opposite side with the locking slider in FIG. 13 omitted.

FIG. 15 is a cross-sectional view taken along F15-F15 in FIG. 13.

FIG. 16 is a view illustrating a state in which a table is installed as a convenience device in a seatback of the present disclosure.

FIG. 17 is a view illustrating an example of a seatback cover installed on a seatback to be opened or closed using a zipper.

### DETAILED DESCRIPTION

If a detailed description of related and/or already known technology would obscure the essence of the examples disclosed herein, the detailed description thereof will be omitted. Further, it is to be understood that the accompanying drawings are only intended to facilitate understanding of the examples disclosed herein and are not intended to limit the technical ideas disclosed herein. The subject matter disclosed herein is not limited to the accompanying drawings and includes all modifications, equivalents, and/or substitutions within the spirit and technical scope of the present disclosure.

Terms including ordinal numbers, such as first, second, and the like, may be used to describe various components (e.g., to distinguish between different elements of the same type), but the components are not to be limited by the terms. The terms may only be used for the purpose of distinguishing one component from another.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

The suffixes “module” and “unit” used for components in the following description are assigned or used interchangeably only in consideration of facilitating the preparation of the specification and are not intended to have distinct meanings or roles in and of themselves.

It is to be understood that when one component is referred to as being “connected” or “linked” to another component, the component may be directly connected or linked but there may be other components in between. In contrast, when one component is referred to as being “directly connected” or “directly linked” to another component, it is to be understood that there is no other component in between.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. The phrase “one or more of” is synonymous with “at least one of” herein.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Any number of components or various components in any configurations among the configurations described in this specification may be included in the disclosure described herein. The components may include any combination of the features described herein and may be arranged in any of the various configurations described herein. The concepts regarding the structure and arrangement as well as the use and operation of the components of the present disclosure may apply not only to the specific examples discussed herein but also to any number of examples in any combination. Examples, including examples with various features in various arrangements, will be described below with reference to the drawings.

Hereinafter, various examples disclosed in the present specification will be described in detail with reference to the accompanying drawings. Identical or similar components are assigned the same reference numerals regardless of drawing designation, and repetitive descriptions will be omitted.

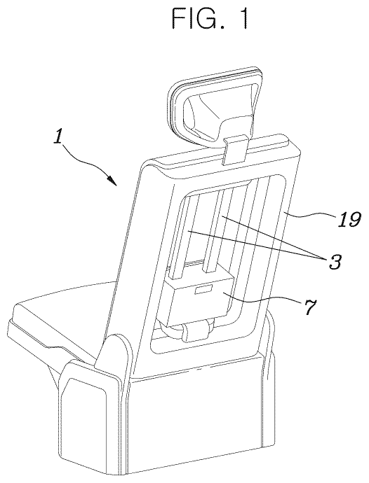

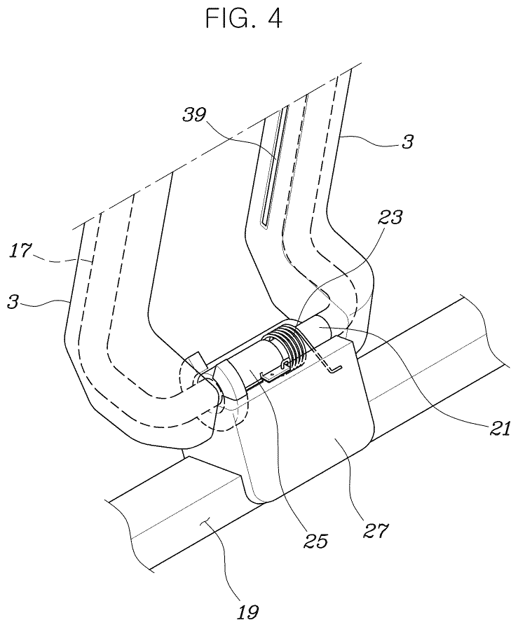

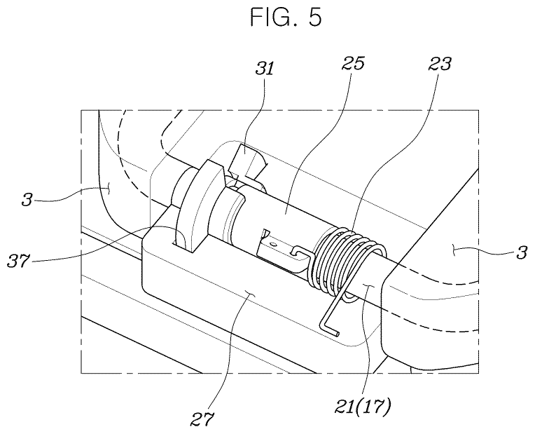

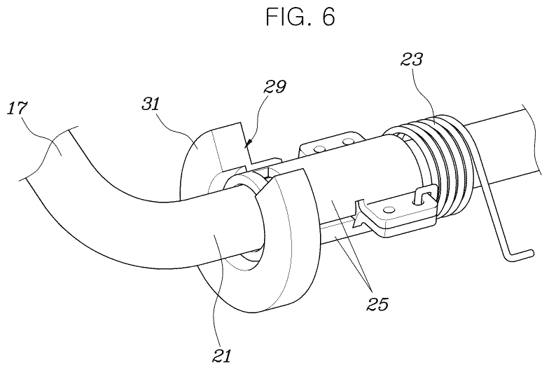

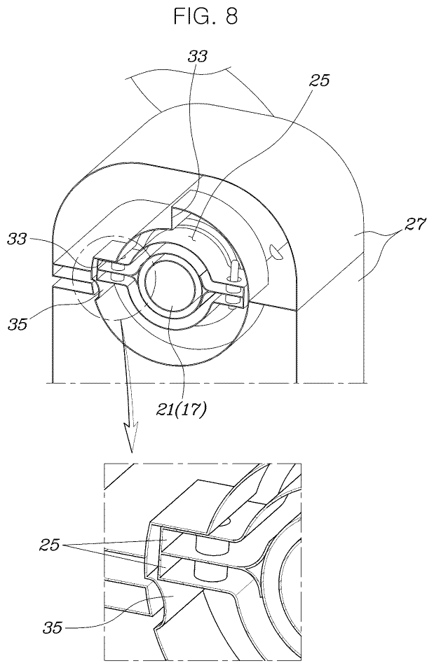

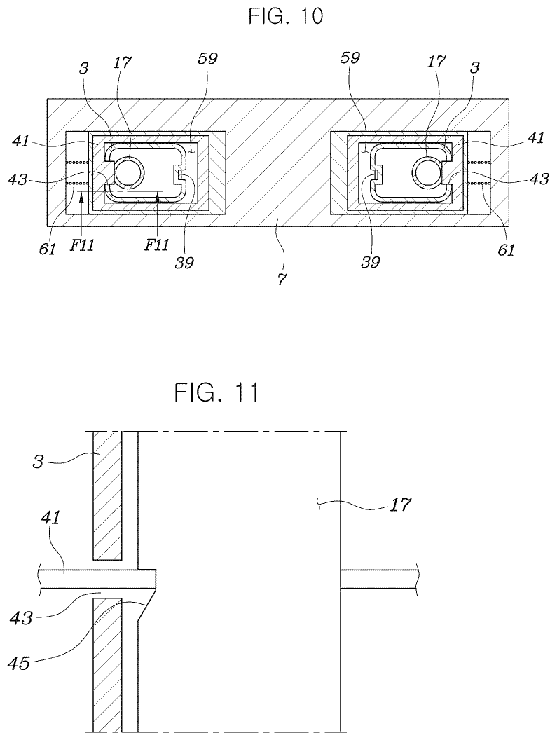

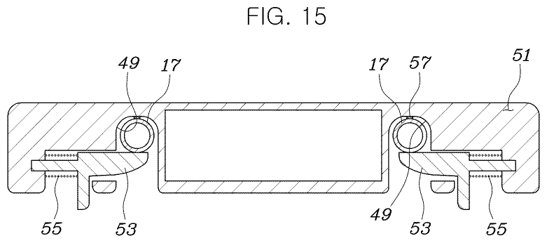

FIGS. 1 to 17 show that a vehicle seatback 1 according to an example of the present disclosure includes a mounting guide 3 protruding rearward from the seatback 1 or stowed inside by rotation and a guide locking device 5 for locking or unlocking the mounting guide 3 into or from a stowed state inside the seatback 1, wherein vertical height relative to the seatback 1 of a convenience device 7 installed in the seatback 1 may be adjusted and fixed in the mounting guide 3.

According to the present disclosure, after disengaging the guide locking device 5 (e.g., to install, remove, and/or replace a convenience device 7 on the mounting guide 3) the mounting guide 3 may be locked using the guide locking device 5 so that various convenience features that may be provided through/via the seatback 1 may be easily modified, replaced, and/or added at any time, thereby maximizing the marketability of the vehicle and convenience of modifying/customizing/configuring the seatback 1.

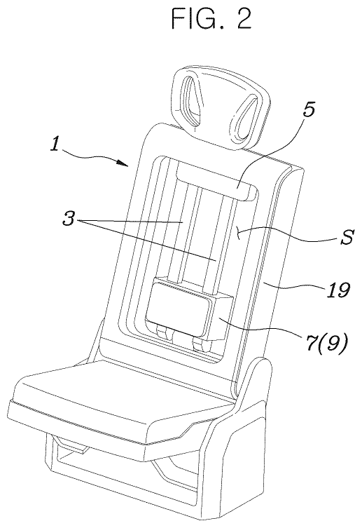

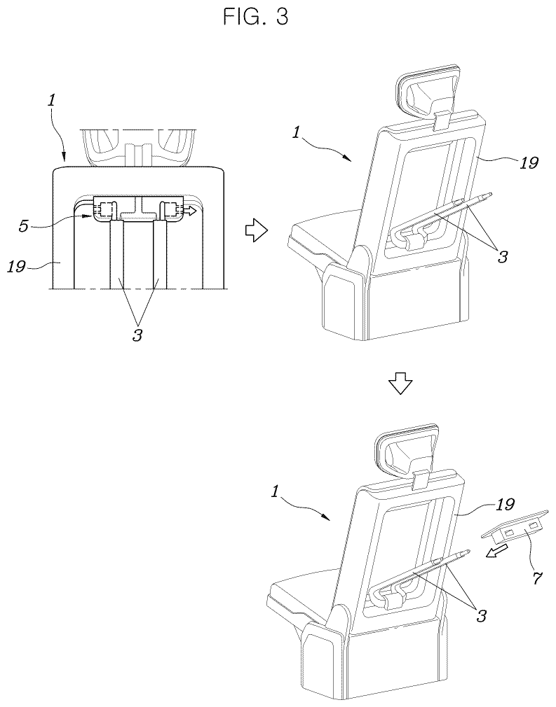

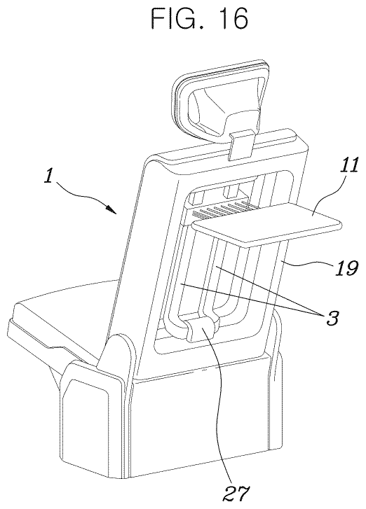

The convenience device 7 may comprise a lumbar support 9 for supporting the passenger's lower back. The convenience device 7 may also, or alternatively, comprise a table 11. FIGS. 1 and 2 illustrate the lumbar support 9, and FIG. 16 illustrates a table 11 protruding rearward from the seatback 1. Various other convenience devices 7 may be installed, and the number of installations may range from zero (e.g., convenience device 7 may be available for installation, but not installed, see, e.g., FIG. 3 installation), to one or more, to two or more, etc.

FIG. 3 shows an example of installing a convenience device 7 to the seatback 1. The guide locking device 5 may be disengaged to allow the mounting guide 3 to protrude rearward from the seatback 1. A convenience device 7 may be installed onto the mounting guide 3. The mounting guide 3 may be secured in an appropriate position. The mounting guide 3 may be stowed inside the seatback 1. The guide locking device 5 may be engaged to lock the mounting guide 3 (e.g., completing the installation of the convenience device 7).

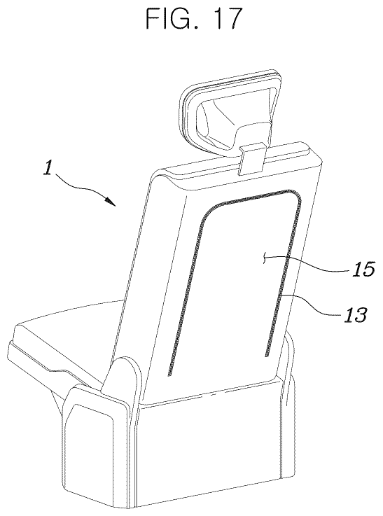

The rear of the seatback 1 may remain open as illustrated in FIG. 1, and/or the components such as the mounting guide 3 inside the seatback 1 may be covered with a seatback cover 15 (e.g., that may be opened and closed using a zipper 13 and/or the like, so as to avoid exposure, as illustrated in FIG. 17).

In the present example, the mounting guide 3 may comprise a plurality of mounting guide structures (e.g., mounting guide bars) (provided parallel to each other such that the convenience device 7 may be inserted thereon and guided in a linear sliding motion. A mounting frame 17 may be inserted inside the mounting guide 3 (e.g., the mounting guide structures/bars). The mounting frame 17 may integrally connect the mounting guide 3 (e.g., the plurality of mounting guide structures/bars and/or include a hinge portion 21 (e.g., a hinge) rotatably secured to the seatback frame 19.

The mounting guide may comprise a plurality of mounting guide structures and/or bars and/or be a rotationally asymmetric mounting guide 3 in a direction of insertion of the convenience device 7. A plurality of mounting guide bars will be discussed herein for ease of explanation. Using a plurality of mounting guide bars allows for the convenience device 7, when inserted onto the plurality of mounting guide bars 3 may be automatically restrained from rotating, may slide linearly in a stable and/or smooth fashion along the plurality of mounting guides 3, and/or may be solidly secured to the seatback frame 19.

The plurality of mounting guides 3 may secure/confer strong rigidity by the insertion of the mounting frame 17 inside. The plurality of mounting guide bars may be structured/configured to rotate uniformly relative to the seatback frame 19 around/via the hinge portion 21 of the mounting frame 17.

The hinge portion 21 of the mounting frame 17 may be elastically supported relative to the seatback frame 19 to provide an elastic force that rotates/assists rotation of the mounting guide 3 rearward from the seatback 1 in the protruding direction.

For example, the hinge portion 21 of the mounting frame 17 may include a pair of hinge plates 25 that are coupled to each other to wrap around the outer circumferential surface of the hinge portion 21. A first end of a hinge spring 23 may be secured to the pair of hinge plates and a second end of the hinge spring 23 may be secured to a hinge cover 27.

Therefore, if the guide locking device 5 is disengaged, the mounting frame 17 and the mounting guide 3 may be rotated rearward from the seatback 1 (e.g., in the protruding direction) by the elastic force provided by the hinge spring 23.

The hinge portion 21 of the mounting frame 17 may include a hinge washer 31 inserted onto the hinge portion 21 through/via an opening 29 in the hinge washer 31. The hinge washer 31 may elastically deform when it is inserted onto the hinge portion, such that it provides an elastic force to support the pair of hinge plates 25 (e.g., by wrapping around at least a portion of the outer circumferential surface of the hinge plates 25).

Also, or alternatively, the seatback frame 19 includes a hinge cover 27 rotatably supporting the hinge portion 21 of the mounting frame 17, the pair of hinge plates 25, and the hinge washer 31 by wrapping around them so that the other end of the hinge spring 23 is supported as described above.

The hinge cover 27 may be divided into upper and lower sections and/or may wrap around the hinge portion 21 of the mounting frame 17, the pair of hinge plates 25, and the hinge washer 31.

A rotation stopper 33 (e.g., formed inside the hinge cover 27) may be configured to restrain the rotation range of the pair of hinge plates 25. The hinge cover 27 may include at least one rotation bumper 35 designed to elastically deform to allow the pair of hinge plates 25 to pass over and come into contact with the rotation stopper 33.

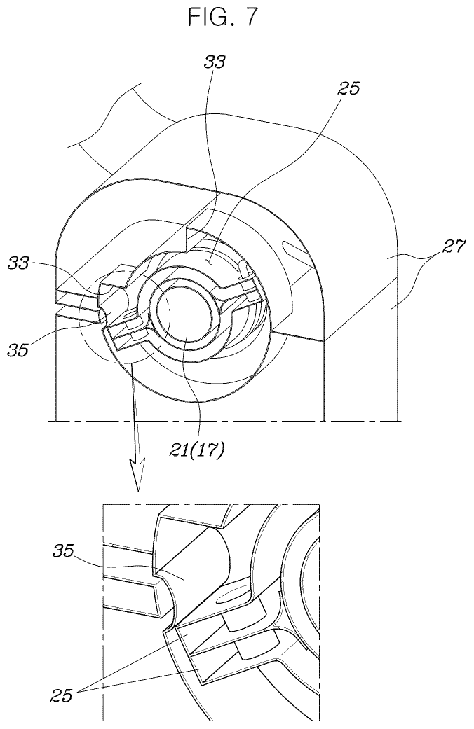

The rotation range of the mounting frame 17 and the mounting guide 3 may be ultimately limited by the rotation stopper 33 (e.g., configured as described herein). The pair of hinge plates 25 may engage with a rotation bumper 35 near the rotation stopper 33. At least a certain level of force (e.g., a minimum force) or more may be required for further rotation of the mounting frame 17 and/or subsequent/additional contact with the rotation stopper 33. Limiting rotation as disclosed herein may allow for a more sophisticated and/or smoother rotation limit for the mounting frame 17 and the mounting guide 3 (see, e.g., FIGS. 7 and 8).

Also, or alternatively, a washer restraint 37 may be formed in the hinge cover 27 to restrain the hinge washer 31 from moving in a longitudinal direction of the hinge portion 21.

The mounting frame 17 and the mounting guide 3 connected (e.g., integrally connected) to the hinge washer 31 may be restrained from moving relative to the seatback 1 in the width direction of the seatback 1 (e.g., longitudinal direction of the hinge portion 21) by the washer restraint 37 of the hinge cover 27.

An exposed conductor 39 may be configured to provide electric power to the convenience device 7. The exposed conductor may be arranged in/on the mounting guide 3 in the length direction of the mounting guide 3.

The convenience device 7 installed in the seatback 1 may easily receive the required electric power via the conductor 39, regardless of the height fixed in the mounting guide 3 (e.g., based on the exposed conductor 39 being arranged and accessible along the length direction of the mounting guide 3).

A plurality of guide locking grooves 43 may be formed in the mounting guide 3 (e.g., spaced along/in the length direction of the mounting guide 3). The plurality of guide locking grooves 43 may be configured to accept insertion of a locking lever 41 provided in the convenience device 7, thereby allowing vertical height adjustment and/or fixation relative to the seatback 1.

Accordingly, the convenience device 7 may be stably secured onto the mounting guide 3 by the locking lever 41 and the guide locking groove 43 at a desired position or a plurality of possible positions.

Also, or alternatively, a plurality of locking notches 45 may be formed in the mounting frame 17 (e.g., spaced along/in the length direction of the mounting frame 17). The plurality of locking notches 45 may be configured to accept insertion of the locking lever 41, of the convenience device 7, when inserted through the guide locking groove 43.

Accordingly, even if the mounting guide 3 does not provide sufficient rigidity required for securing the convenience device 7 (e.g., even if the mounting guide 3 is made of plastic resin, etc., lacking the required rigidity/strength), the convenience device 7 may be secured more stably and firmly by the high strength provided by the locking notch 45 of the mounting frame 17.

The mounting frame 17 may be made of a material (e.g., a metal) having a higher strength than a material of the mounting guide 3.

The conductor 39 of the mounting guide 3 and/or the guide locking groove 43 may be arranged on the opposite sides of the mounting frame 17 on the cross-section perpendicular to the mounting guide 3 (e.g., in a cross-section perpendicular to the length direction of the mounting guide 3).

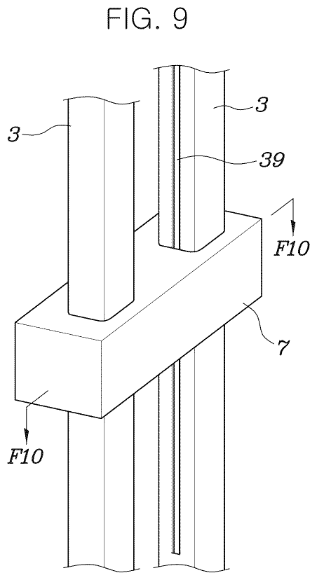

As illustrated in FIG. 10, for example, the conductor 39 and the guide locking groove 43 may be arranged on the opposite sides of the mounting frame 17 so that issues of the locking lever 41 of the convenience device 7 coming into contact with the conductor 39 (e.g., which may damage the conductor 39 and/or create undesirable electrical connections) may be effectively prevented.

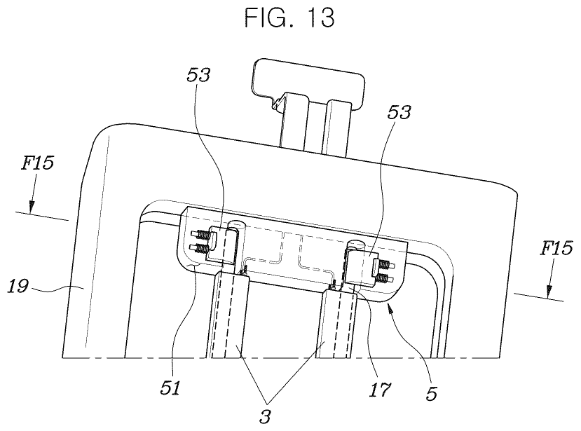

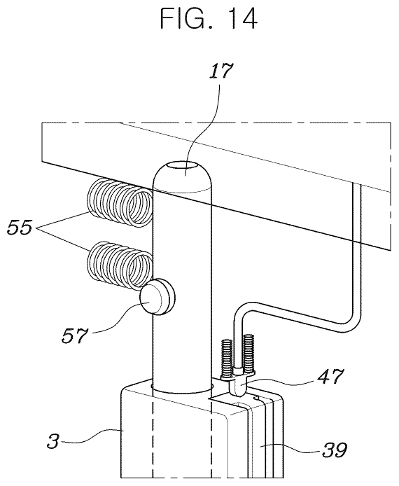

FIGS. 13 and 14 show a supply pogo pin 47 installed in the guide locking device 5 to elastically protrude toward a portion of the conductor 39 exposed at the upper end of the mounting guide 3. The supply pogo pin 47 may provide electric power to the conductor 39 of the mounting guide 3 (e.g., when/if the mounting guide 3 is stowed inside the seatback 1 and locked by the guide locking device 5).

Electric power may not be provided to the conductor 39 of the mounting guide 3 in the state where the mounting guide 3 protrudes rearward from the seatback 1. The electric power may be provided to the conductor 39 via contact with the supply pogo pin 47, which may only occur when the mounting guide 3 is retracted into the seatback 1 (e.g., in the stowed state configured to be locked by the guide locking device 5).

In the present example, the upper end of the mounting frame 17 may protrude through/into the mounting guide 3. The guide locking device 5 may lock or unlock the upper end of the mounting frame 17 protruding through the mounting guide 3 in or from the seatback frame 19.

A more robust and stable locked state and durability of the mounting guide 3 may be secured by locking the relatively high-strength mounting frame 17 using the guide locking device 5.

In the present example, the guide locking device 5 may include a guide locking cover 51 that is fixed to the seatback frame 19 and in which a frame locking groove 49 accommodating the upper end of the mounting frame 17 may be formed. The guide locking device 5 may include a locking slider 53, which may be slidably installed to allow for restraining the mounting frame 17 when/if the mounting frame 17 is inserted into the frame locking groove 49. The guide locking device may further comprise a slider spring 55 elastically supporting the locking slider 53 in a direction to restrain the mounting frame 17.

The locking slider 53 may have an inclined surface configured such that, when the mounting frame 17 is moved towards the frame locking groove 49 from outside of the frame locking groove 49 (e.g., when the mounting frame 17 is pressed toward the seatback 1 from the rear side of the seatback 1), the mounting frame 17 may press the inclined surface of the locking slider 53, which may cause the locking slider 53 to move in opposition to (e.g., to compress) the slider spring 55. The mounting frame 17 may be accommodated in the frame locking groove 49 when the locking slider 53 moves (by pressure along the inclined surface) out of the way of the frame locking groove 49. Once the mounting frame 17 is accommodated in the frame locking groove, the locking slider 53 may be moved back to an initial position covering (at least in part) the frame locking groove 49 by the slider spring 55 again, thereby restraining the mounting frame 17 accommodated in the frame locking groove 49.

The locking slider 53 may be disengaged manually (e.g., by manipulation of tabs protruding rearward from the seatback) and/or automatically.

A damper 57 may be installed in the frame locking groove 49 of the guide locking device 5. The damper 57 may provide a cushioning force to the mounting frame 17 inserted in the frame locking groove 49.

As described herein, when/if the mounting frame 17 is inserted into the frame locking groove 49 (e.g., by pressing the mounting frame 17 toward the seatback 1), the damper 57 may suppress or reduce the shock, noise, or vibration of insertion of the mounting frame 17 in the frame locking groove.

As illustrated in FIG. 17, for example, a seatback cover 15 that may be opened or closed to cover or expose the mounting guide 3 in the stowed state may be installed in the seatback 1.

FIG. 17 illustrates the seatback cover 15 in which the part where the mounting guide 3 protrudes may be opened and/or closed using a zipper 13.

The seatback 1 may include a space S configured to allows transmission of the physical quantity generated by the convenience device 7 secured to the mounting guide 3 to an occupant in the front. For example, a physical quantity of a convenience device may be displacement/structure for lumbar support in the case of lumbar support 9 in/of the convenience device, heat of a heat source for warming a back of an occupant of a seat with the seatback 1, a table storage/device stand configured to be stowed in or protrude out of the seatback 1, etc.

For example, the space S may allow for transmitting the displacement provided by the lumbar support 9 installed as the convenience device 7 to an occupant in front of the seatback 1.

A separate soft cover may be provided in front of the seatback 1 such that the space S is not exposed. The soft cover may be configured to allow for transmission of physical quantity transmitted through the space S to the occupant.

As described herein, the convenience device 7 inserted onto the mounting guide 3 may include at least one lumbar support 9 transmitting displacement to the front of the seatback 1 or a table 11 configured to protrude rearward from the seatback 1, or be stowed in the seatback 1.

As described above, the convenience device 7 that may be installed in the vehicle seatback 1 may include one or more (e.g., a plurality of) guide holes 59 into which the plurality of mounting guide bars 3 may be respectively inserted. The convenience device 7 may further comprise the locking lever 41 configured to be inserted into the guide locking groove 43 of the mounting guide 3 through the guide hole 59. The convenience device may comprise the lever spring 61 supporting the locking lever 41 toward the guide locking groove 43 elastically.

Also, or alternatively, the convenience device 7 may further include a supply/receiving pogo pin 63 elastically protruding toward the conductor 39 of the mounting guide 3 through the guide hole 59 to receive electric power from the conductor 39 when/if electric power is required for operation.

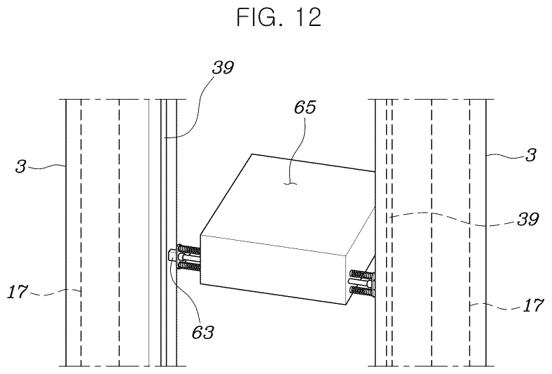

FIG. 12 conceptually illustrates the electric power supply through the supply/receiving pogo pin 63 from the conductor 39 to a convenience control module 65 which is provided in the convenience device 7 and which requires electric power.

An object of the present disclosure is to provide a vehicle seatback that allows various convenience features that may be provided through the seatback to be easily modified, replaced, or installed at any time, thereby ultimately maximizing the marketability of the vehicle.

The technical issues that the present disclosure aims to address are not limited to the technical issues mentioned above, and other unmentioned technical issues will be clearly understood by those skilled in the art to which the present disclosure pertains from the following description.

A vehicle seatback according to the present disclosure for achieving the object described above includes a mounting guide protruding rearward from the seatback or stowed inside by rotation and a guide locking device for locking or unlocking the mounting guide into or from a stowed state inside the seatback, wherein vertical height relative to the seatback of a convenience device installed in the seatback may be adjusted and fixed in the mounting guide.

A plurality of mounting guides may be provided parallel to each other so that the convenience device is inserted thereon and guided into a linear sliding motion, a mounting frame may be inserted inside the mounting guide, and the mounting frame may include a hinge portion integrally connecting the plurality of mounting guides and rotatably secured to the seatback frame.

The hinge portion of the mounting frame may be elastically supported relative to the seatback frame to provide an elastic force that rotates the mounting guide rearward from the seatback in the protruding direction.

The hinge portion of the mountain frame may include a pair of hinge plates that are coupled together to wrap around the outer circumferential surface of the hinge portion and to which one end of a hinge spring is secured.

The hinge portion of the mounting frame may include a hinge washer inserted onto the hinge portion through an opening while elastically deforming to support the pair of hinge plates by wrapping around the outer circumferential surface.

The seatback frame may include a hinge cover rotatably supporting the hinge portion of the mounting frame, the pair of hinge plates, and the hinge washer by wrapping around them; and the hinge cover may support the other end of the hinge spring.

A rotation stopper restraining the rotation range of the pair of hinge plates may be formed in the hinge cover and the hinge cover may include at least one rotation bumper designed to elastically deform to allow the pair of hinge plates to pass over and come into contact with the rotation stopper.

A washer restraint may be formed in the hinge cover to restrain the hinge washer from moving in the longitudinal direction of the hinge portion.

An exposed conductor for providing electric power to the convenience device may be long arranged in the mounting guide in the length direction of the mounting guide.

A plurality of guide locking grooves may be formed in the mounting guide in the length direction of the mounting guide to insert a locking lever provided in the convenience device and adjust and fix the vertical height relative to the seatback.

A plurality of locking notches into which the locking lever of the convenience device is inserted through the guide locking grooves may be formed in the mounting frame, inserted into the mounting guide, in the length direction of the mounting frame.

The conductor of the mounting guide and the guide locking groove may be arranged on the opposite sides of the mounting frame on the cross-section perpendicular to the mounting guide in the length direction.

The guide locking device may include a supply pogo pin elastically protruding toward the conductor exposed at the upper end of the mounting guide to provide electric power to the conductor of the mounting guide when the mounting guide is stowed inside the seatback and locked by the guide locking device.

The upper end of the mounting frame may protrude through the mounting guide and the guide locking device may lock or unlock the upper end of the mounting frame protruding through the mounting guide relative to the seatback frame.

The guide locking device may include a guide locking cover that is fixed to the seatback frame and in which a frame locking groove accommodating the upper end of the mounting frame is formed, a locking slider slidably installed to restrain the mounting frame inserted into the frame locking groove, and a slider spring elastically supporting the mounting frame in the direction to restrain the mounting frame.

The frame locking groove of the guide locking device may include a damper for providing a cushioning force when the mounting frame is inserted.

A seatback cover that may be openably installed on the seatback to cover or expose the mounting guide in a stowed state.

The convenience device inserted onto the seatback guide may comprises at least one of a lumbar support transmitting displacement to the front of the seatback, and table protruding rearward from the seatback.

Also, or alternatively, as described above, the convenience device that may be installed in the vehicle seatback includes a plurality of guide holes into which the plurality of mounting guides are respectively inserted, the locking lever inserted into the guide locking groove of the mounting guide through the guide hole, and a lever spring supporting the locking lever toward the guide locking groove elastically.

Also, or alternatively, the convenience device may further include a supply/receiving pogo pin elastically protruding toward the conductor of the mounting guide through the guide hole to receive electric power from the conductor.

The present disclosure allows various convenience features that may be provided through the seatback to be easily modified, replaced, or installed at any time, thereby ultimately maximizing the marketability of the vehicle.

The effects obtainable from the present disclosure are not limited to the effects mentioned above, and other unmentioned effects will be clearly understood by those skilled in the art to which the present disclosure pertains from the following description.

Specific examples of the present disclosure are illustrated and described, but it will be evident to those skilled in the art that the present disclosure may be improved upon and modified in various manners within the scope not deviating from the technical spirit of the present disclosure provided in the following patent claims.

What is claimed is:

1. A vehicle seatback comprising:
a mounting guide configured to switch, by rotation, between:
a protruding state in which the mounting guide protrudes rearward from the vehicle seatback, and
a stowed state in which the mounting guide is stowed inside the vehicle seatback; and
a guide locking device configured to:
lock the mounting guide into the stowed state, or
unlock the mounting guide from the stowed state,
wherein the mounting guide is configured to accommodate a convenience device installed on the mounting guide such that a position, of the convenience device along the mounting guide in a length direction of the mounting guide, is able to be adjusted and fixed.

2. The vehicle seatback of claim 1, wherein
the mounting guide comprises a plurality of mounting guide bars provided parallel to each other, so as to be able to guide the convenience device, when installed on the plurality of mounting guide bars,, in a linear sliding motion,
a mounting frame is inserted inside the plurality of mounting guide bars, and
the mounting frame comprises a hinge integrally connecting the plurality of mounting guide bars and rotatably secured to a seatback frame of the vehicle seatback.

3. The vehicle seatback of claim 2, wherein the hinge is elastically supported, relative to the seatback frame, to provide an elastic force to rotate the plurality of mounting guide bars rearward from the vehicle seatback in a protruding direction.

4. The vehicle seatback of claim 3, wherein the hinge comprises:
a pair of hinge plates that are coupled together to wrap around an outer circumferential surface of the hinge, and
a hinge spring comprising a first end secured to the pair of hinge plates.

5. The vehicle seatback of claim 4, wherein the hinge comprises a hinge washer wrapped around at least a portion of an outer circumferential surface of the pair of hinge plates, wherein the hinge washer, when wrapped around at least the portion of the outer circumferential surface of the pair of hinge plates, is elastically deformed so as to provide an elastic force that supports the pair of hinge plates.

6. The vehicle seatback of claim 5, wherein:
the seatback frame comprises a hinge cover that wraps around and rotatably supports the hinge of the mounting frame, the pair of hinge plates, and the hinge washer, and
the hinge cover supports a second end of the hinge spring.

7. The vehicle seatback of claim 6, wherein the hinge cover comprises:
a rotation stopper configured to restrain a rotation range of the pair of hinge plates; and
at least one rotation bumper configured to elastically deform to allow the pair of hinge plates to pass over and come into contact with the rotation stopper.

8. The vehicle seatback of claim 6, wherein the hinge cover comprises a washer restraint configured to restrain the hinge washer from moving in a longitudinal direction of the hinge.

9. The vehicle seatback of claim 2, further comprising a conductor arranged in the mounting guide in the length direction of the mounting guide, wherein the conductor is configured to provide power to the convenience device when the convenience device is installed on the mounting guide.

10. The vehicle seatback of claim 9, wherein the mounting guide forms a plurality of guide locking grooves spaced apart in the length direction of the mounting guide, wherein the plurality of guide locking grooves are each configured to accept a locking lever of the convenience device to fix the position of the convenience device along the mounting guide.

11. The vehicle seatback of claim 10, wherein the mounting frame forms a plurality of locking notches corresponding to the plurality of guide locking grooves, wherein the plurality of locking notches are each configured to accept the locking lever of the convenience device via a corresponding guide locking groove of the plurality of guide locking grooves.

12. The vehicle seatback of claim 9, wherein the guide locking device comprises a supply pogo pin elastically protruding toward a portion of the conductor exposed at an upper end of the mounting guide and configured to, based on the mounting guide being in the stowed state and locked by the guide locking device, provide electric power to the conductor.

13. The vehicle seatback of claim 2, wherein:
an upper end of the mounting frame protrudes through the plurality of mounting guide bars; and
the guide locking device is configured to lock or unlock the upper end of the mounting frame protruding through the mounting guide relative to the seatback frame.

14. The vehicle seatback of claim 13, wherein the guide locking device comprises:
a guide locking cover, secured to the seatback frame, forming a frame locking groove configured to accommodating the upper end of the mounting frame;
a locking slider configured to slidably restraining the mounting frame inserted into the frame locking groove; and
a slider spring configured to elastically support the locking slider in a direction to restrain the mounting frame.

15. The vehicle seatback of claim 14, wherein the guide locking device further comprises a damper in the frame locking groove configured to provide a cushioning force when the mounting frame is inserted in the frame locking groove.

16. The vehicle seatback of claim 1, further comprising a seatback cover configured to cover or expose the mounting guide in the stowed state.

17. The vehicle seatback of claim 1, wherein the convenience device comprises at least one of a lumbar support configured to transmit displacement to a front of the vehicle seatback, or a table configured to protrude rearward from the vehicle seatback.

18. A convenience device configured to be installed in the vehicle seatback of claim 11, the convenience device comprising:
a guide hole configured to accept insertion of the mounting guide;
the locking lever configured to be inserted into a guide locking groove of the plurality of guide locking grooves of the mounting guide inserted in the guide hole; and
a lever spring configured to elastically support the locking lever toward the guide locking groove.

19. The convenience device of claim 18, further comprising a pogo pin configured to elastically protrude through the guide hole toward the conductor of the mounting guide so as to receive electric power from the conductor.

20. A seatback comprising:
a mounting guide comprising a plurality of mounting guide bars rotatably attached to the seatback and configured to switch, by rotation, between:
a protruding state in which the plurality of mounting guide bars protrude rearward from the seatback, and
a stowed state in which the plurality of mounting guide bars are stowed inside the seatback;
wherein each mounting guide bar, of the plurality of mounting guide bars, forms a plurality of guide locking grooves spaced apart in a length direction of the mounting guide; and
a convenience device comprising:
a plurality of guide holes configured to accept insertion of the plurality of mounting guide bars, wherein each of the plurality of guide holes comprises:
a locking lever configured to be inserted into a guide locking groove of the plurality of guide locking grooves of an inserted mounting guide bar of the plurality of mounting guide bars; and
a lever spring configured to elastically support the locking lever toward the guide locking groove.
